(19) United States
(12) Patent Application Publication
(10) Pub. No.: US 2016/0371627 A1
(43) Pub. Date: Dec. 22, 2016

(54) METHOD AND SYSTEM FOR IDENTIFICATION OF BUSINESS COLLABORATORS

(71) Applicant: DEREK ESTLIN PURVIS, (US)

(72) Inventor: DEREK ESTLIN PURVIS, VALENCIA, CA (US)

(73) Assignee: DEREK ESTLIN PURVIS, VALENCIA, CA (US)

(21) Appl. No.: 15/186,117

(22) Filed: Jun. 17, 2016

Related U.S. Application Data
(60) Provisional application No. 62/182,320, filed on Jun. 19, 2015.

(51) Int. Cl. G06Q 10/06; G06F 17/30

(52) U.S. Cl. CPC G06Q 10/063118; G06F 17/30864; G06F 17/3053

(57) ABSTRACT

A system and method approach for processing collaborator data and identifying a plurality of potential collaborators and then transforming the potential collaborators by ranking the potential collaborators and associating each of the potential collaborators with analytics.

### RELATED APPLICATION

This application claims priority to U.S. Provisional Application with Ser. No. 62/182,320, titled METHOD AND SYSTEM FOR IDENTIFICATION OF BUSINESS COLLABORATORS, filed on Jun. 19, 2015, and herein incorporated by reference.

### FIELD OF THE INVENTION

The invention relates generally to the identification and analysis of potential collaborators for a project or business and more specifically, researching, compiling, and ranking relevant data for potential project collaborators.

### BACKGROUND

Often in business and other endeavors, collaborators are desired and sought out. This activity is generally referred to as “pounding the pavement” or “shopping an idea around.” When collaborators are sought out, time is often short and the amount of research data available is limited. Much time is wasted on approaching potential collaborators that were erroneously identified rashly due to time constraints and limited data.

Examples of types of collaborators that are often sought out include movie production companies, business partners, and merger candidates. The task of developing a quantified list of potential collaborators or business partners is a daunting, time consuming, and challenging task. When a project or business identifies a need for collaboration, it typically relies on manual research for identifying potential targets and attempts to gather relevant information to identify appropriate targets to approach. More often than not, the research done includes only a tiny fraction of the possible collaborators due to time constraints.

What is needed in the art is an approach for rapidly identifying and ranking collaborators that solve the problems identified above.

### SUMMARY

In accordance with one embodiment of the disclosure, an approach for processing project and collaborator data with a processing unit and identifying a plurality of potential collaborators. The identified plurality of potential collaborators are then transformed into a ranked list by assigning a ranking to each of the potential collaborators and associating each of the ranked potential collaborators with analytics.

The above described features and advantages, as well as others, will become more readily apparent to those of ordinary skill in the art by reference to the following detailed description and accompanying drawings. While it is desirable to provide an approach for identification and ranking of potential collaborators, the teachings disclosed herein also extend to those embodiments which fall within the scope of the appended claims, regardless of whether they accomplish one or more of the above-mentioned advantages.

### BRIEF DESCRIPTION OF THE DRAWINGS

FIG. 1 is an exemplary depiction of a block diagram of a processing unit with a controller in accordance with an example implementation of the invention;

FIG. 2 is a depiction of a flow diagram of an approach for identifying and ranking potential collaborators executed by the controller of FIG. 1 in accordance with an example implementation;

FIG. 3 is a further depiction of a flow diagram of an approach for identifying and ranking potential collaborators executed by the controller of FIG. 1 in accordance with an example implementation;

FIG. 4 is a depiction of a block diagram of database 124 of FIG. 1 in accordance with an example implementation;

FIG. 5 is a depiction of a block diagram of the approach for identifying and ranking potential collaborators of FIG. 2 when no matches occur in accordance with an example implementation;

FIG. 6 is an illustration the collaborator ranking module processing unranked collaborators results list of FIG. 1 in accordance with an example implementation of the invention; and

FIG. 7 is an illustration a ranked collaborators result list of FIG. 6 with associated analytics in accordance with an example implementation of the invention.

### DESCRIPTION

An example embodiment of an approach for processing collaborator data and identifying a plurality of potential collaborators and then transforming the identified potential collaborators by ranking the potential collaborators and associating each of the potential collaborators with analytics is described.

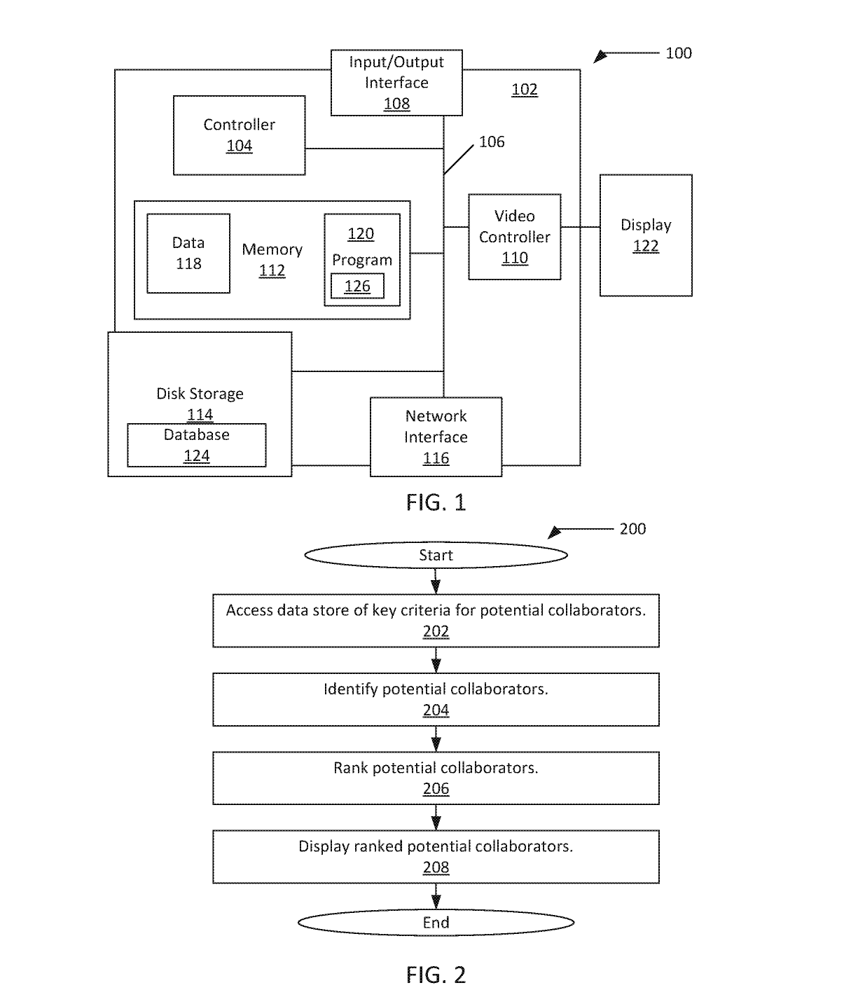

In FIG. 1, an exemplary block diagram 100 of a processing unit 102 with a controller 104 in accordance with an example implementation of the invention is depicted. The controller 104 may be a microprocessor, microcontroller, digital signal processor, or a combination of digital and/or analog circuits executing a state machine. The controller 104 is shown as coupled to a data/address bus 106 that enables data to be transferred between components of the processing unit 102. The data/address bus 106 also provides communication to an input/output module 108, video controller 110, memory 112, disk storage 114, and a network interface 116. The memory 112 may be further logically or physically divided into a data memory 118 and a program memory 120. The data memory 118 is typically read/write type memory (commonly referred to as random access memory). Program memory 118 may be random access memory (RAM), written, or burned memory commonly called ROM that typically has instructions for execution by the controller 104. In other implementations, a single undivided memory may be used. The program memory 118 may have instructions for ranking potential collaborators via a ranking module 126. The ranking module 126 may use algorithms such as weighted ranking, match ranking, or other known ranking approaches to rank the potential collaborator based partially upon potential collaborator data.

The video controller converts 110 digital data into video data for display on a video monitor display 122 or other display device. The input/output interface 108 enables other devices to be coupled to and in signal communication with the processing unit 102. Examples of input/output interface 108 include universal serial bus, serial ports, parallel ports, and small computer serial interface (SCSI) ports, to name but a few. The network interface 116 may be an internet connection via wired and/or wireless connection that enables communication with other devices such as servers, clients, printers, and cloud based services.

A plurality of information data associated with a plurality of project data may be stored in disk storage 114 in the current example. The data may be of movie projects and have key criteria such as genera, budget, theme, production company, director, producer, etc. . . . Typically, there is no ordering or ranking of the data (potential collaborator data). The data may be stored in a relational database 124 that resides in memory or more preferably the disk storage 114 (or even cloud storage). In other implementations, other types of data structures or databases may be used to save or otherwise store the data.

Turning to FIG. 2, a flow diagram 200 of an approach for identifying and ranking potential collaborators executed by the controller 104 of FIG. 1 in accordance with an example implementation is depicted. A data store, such as disk storage 114 contains data including key criteria associated with a plurality of projects and potential collaborators. The project data and potential collaborators data contained in the data store is accessed in step 202 by controller 104 in response to instructions executed from program memory 120. Selection criteria associated with a user's project are entered by a user via input/output interface 108 and used to identify similar projects and associated potential collaborators in step 204. The identified potential collaborators are ranked in the current implementation in step 206. The ranking may be based upon at least a portion of the user selection criteria and freshness of the potential collaborators data and project data. The resulting identified ranked potential collaborators are displayed in step 208 on display 122.

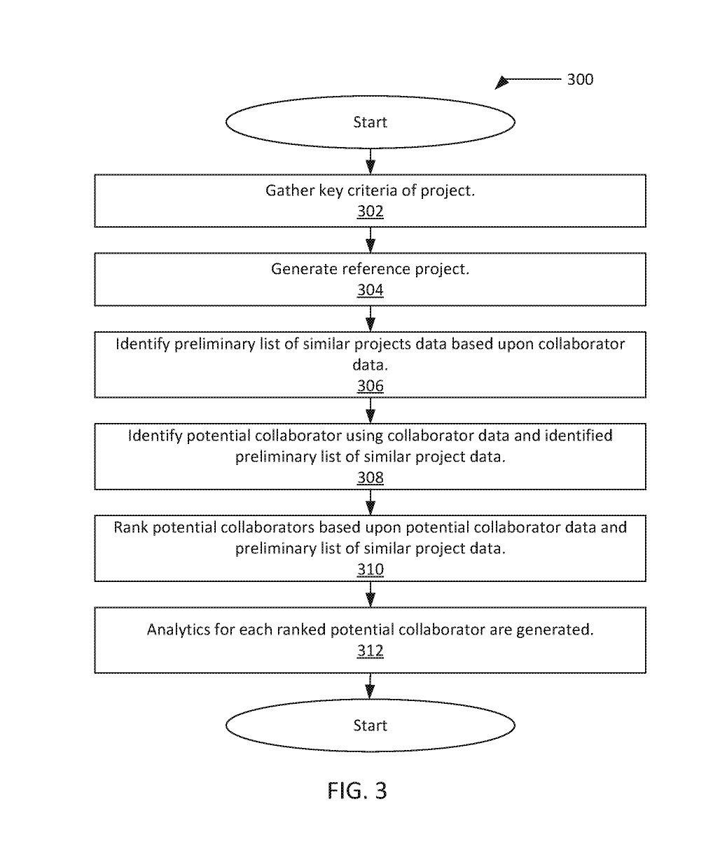

In FIG. 3, a flow diagram 300 of an approach for identifying and ranking potential collaborators executed by the controller of FIG. 1 in accordance with an example implementation is further depicted. The key criteria or components of projects are stored in the data store (i.e. disk storage 114) and may also contain collaborator data. In other implementations, the data store may reside remotely in a network, wide area network, or Internet/cloud. A user may be prompted on display 122 in response to instructions executed by the controller 104 to enter key criteria of their project. Key criteria of the project in the current example may include but are not limited to, genre, budget, theme, production company, director, producer, in step 302.

A user may also be prompted to answer a plurality of questions that results in a reference project being generated using the previously entered key components in step 304. In step 306, a preliminary list of similar projects is identified and/or generated based upon the key criteria of the reference project. The generation of the list of potential projects may be based upon the number of user's key criteria that directly match key criteria associated with project data contained in the data store. In other implementations, the generation of the list may be based upon key criteria being used to derive additional components or key criteria that are then matched or compared with key criteria for projects stored in the data store. The matching may also be done using correlation scores which are generated for the projects stored in the data store.

Once a preliminary list of similar projects is identified in step 306, potential collaborators are identified using collaborator data associated with the projects in the preliminary list of similar projects in step 308. A ranking module may then be executed by the controller to rank potential collaborators based upon potential collaborator data and preliminary list of similar project data, resulting in a list of ranked projects in step 310. The ranked potential collaborators may then have additional analytics identified and associated with each of the potential collaborators in step 312. In addition to general analytics (analytics associated with key criteria), analytics associated with individual identified collaborators may be accessed and displayed. The non-general analytics may be identified by post-processing the list of ranked potential collaborators. The post-processing may be in response to selection of a potential collaborator by the user.

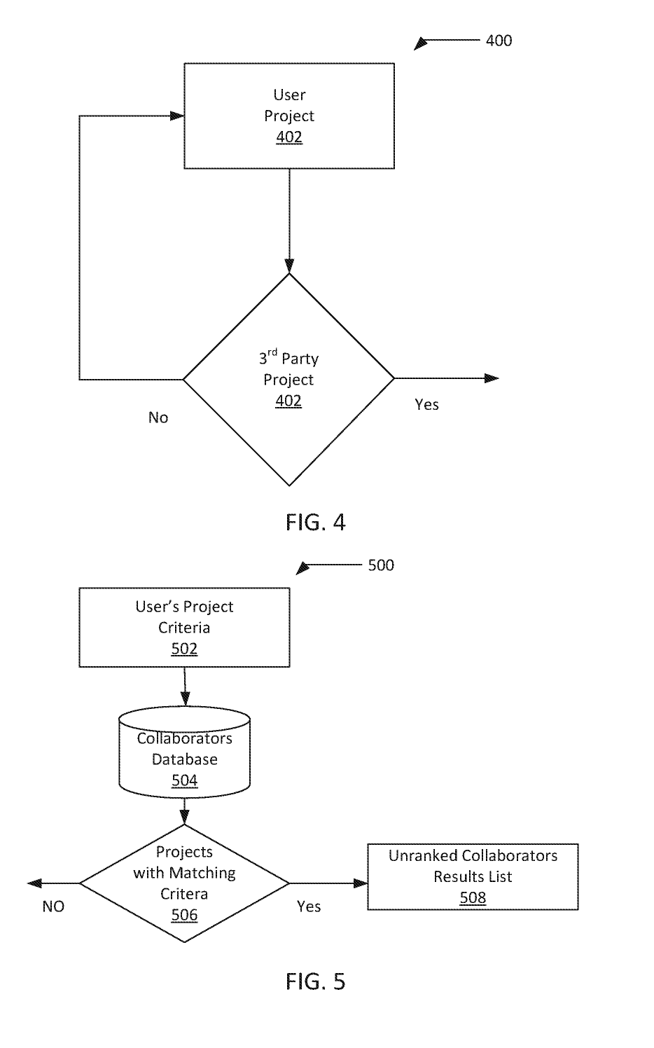

Turning to FIG. 4, a block diagram of database 124 of FIG. 1 in accordance with an example implementation is depicted. The database 124 may have storage or tables for third party records 402 with multiple third party project records 404-410 being stored in that area of the database 124. Each third party project records 404-410 may contain sub-records or data associated with that project. Potential collaborator data may be stored in the sub-records of the third party project records 402-408 and/or in a separate part of the database 124 or even a separate database. In some implementations, the potential collaborator data may be completely derived from or partially derived from the third party project records 404-410.

In FIG. 5, a block diagram 500 of the approach for identifying and ranking potential collaborators of FIG. 2 when no matches to projects occur in accordance with an example implementation is depicted. A user's project key components 502 are entered in response to instructions being executed by the controller 104. In some implementations, the entry of the project key criteria 502 may be accomplished in a windowing environment (or operating system) with a graphical user interface prompting the user for data, such as the key components. The responses to the prompts may be entered by a touch screen, mouse, keyboard, or other input device coupled to the processing unit 102 via the input/output interface 108. In other implementations, a form may be filled out by a user and scanned into the system for the system to receive the user's key criteria associated with the user's project. The user's key criteria (i.e. selection criteria) 502 are then used to identify potential collaborators using the collaborator data and project data stored in a data store, such as collaborators database 504. If the user's key criteria are matched to key criteria associated with stored project data in 506, an unranked collaborators results list may be generated 508. But, it is possible in some implementations that no matches or correlations may be found in 506 and processing will end or generate an event message that is displayed for the user and ask the user to refine the user's project key criteria. In some implementations the possible key criteria may be predefined and selected from pull down menus or with radio buttons in a graphical user interface.

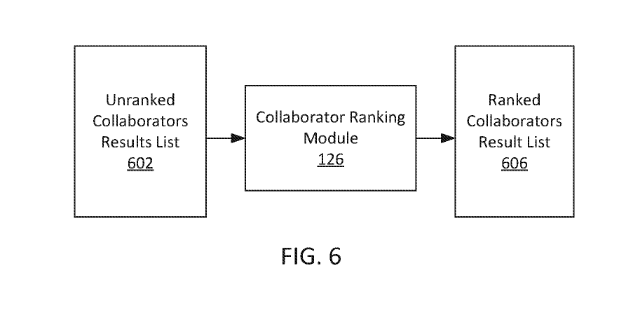

Turning to FIG. 6, the collaborator ranking module 126 of FIG. 1 processing the unranked collaborators results list 602 is illustrated in accordance with an example implementation of the invention. An unranked collaborators results list 602 is generated by the processing unit 102. The collaborator ranking module 126 processes the list and ranks the collaborators based on a predetermined (or preselected) ranking approach or algorithm in order to generate a ranked collaborators result list 606. Typically, the ranking of collaborators will be based upon the most key criteria matched or the projects with the highest correlation values being listed first. But in some implementations, the aging of the data may alter or modify the weight given to the relevance of the key components when ranking occurs in the collaborator ranking module 126, resulting in a weighted ranking or weighted correlation ranking. Weighted rankings may also be based on the importance of each key criteria.

Further in some implementations, the ranked collaborators list 606 may be ranked using an algorithm that compares each of the selection criteria key components with each of the key criteria associated with the projects in the database. The matches between selection criteria and key criteria. The key components may have different importance and be prioritized accordingly. Finally, the percentage of the matches made as compared to total number of associated key criteria searched in the database. The resulting value may then be combined to rank the projects and similarly rank the collaborators list 606.

To further define the results, filters may also be applied to the ranked collaborators list 606. Examples of filters may include date of last project, location of potential collaborator, awards won by collaborator, success of last project, etc. . . .

An example of execution of ranking by the collaborator ranking module 126 may be described using the movie industry. Third party project records may contain information or data points about past projects different movie studios have completed, along with associated information such as genre, directors, budgets, production time, along with multiple other data points. Additional third party project records may contain current projects studios are working on and associated data for those projects. If a user's key criteria include horror movies with budgets less than five million dollars, potential collaborators would be identified as movie studios that have made horror movies with budgets less than five million dollars. Generated data from the third party project data may include a percentage for horror movies made by a movie studio compared to all the movies made by that movie studio and associated data, percentage of horror movies currently in production by a movie studio and associated data. The resulting identified movie studios and associated data may then be presented in an unranked collaborators results list 602. The percentages derived for the movie studios that made or are making horror movies may then also be weighted, assigned values, and combined to generate a ranking value in the collaborator raking module 126. The ranking value may then be used to rank each of the potential collaborators in the ranked collaborators result list 606.

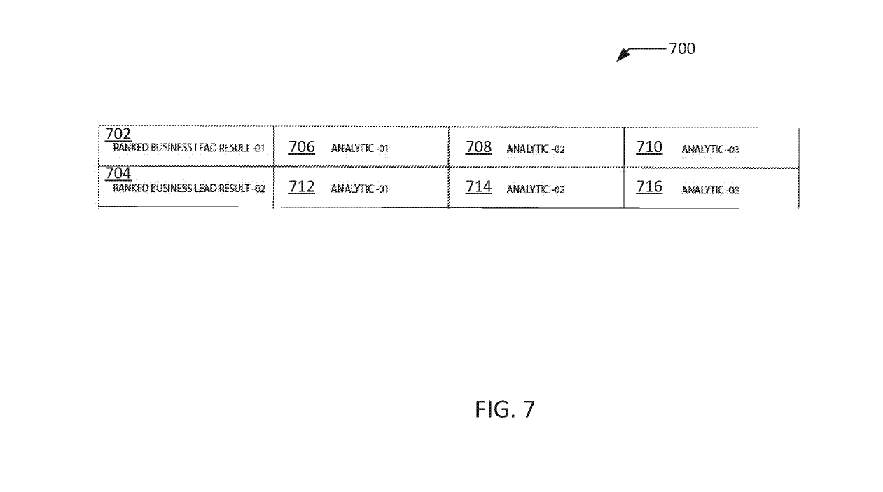

In FIG. 7, the ranked collaborators result list 606 of FIG. 6 with associated analytics in accordance with an example implementation of the invention is illustrated. In the example of FIG. 7, key criteria of potential business leads are entered and a data store of potential business leads accessed. Examples of some key criteria may include size of company, public vs. private ownership, number of employees, materials produced, materials consumed, etc. . . . The resulting ranked collaborators result list 606 is a list of ranked business leads. Every business lead in the ranked business leads may have additional analytic data, such as the first ranked business lead 702 having analytic data 706-710 and the second ranked business lead 704 having 712-716.

The analytics may not reside in the data store, but may be generated by accessing additional databases and data stores that reside in the internet or other network. For example, a ranked business lead may have analytics of Security Exchange Commission (SEC) filing by the ranked business, number of Better Business bureau reports for the last year. The type of complexity of the associated analytics may require a separate analytic module to be present in the processing unit and may be implemented with instructions stored in program memory. The analytics module has the ability to access external data sources/data bases via a network, such as the internet and retrieve predefined data, such as SEC filings, SEC filing counts, etc. . . .

It will be understood, and is appreciated by persons skilled in the art, that one or more processes, sub-processes, or process steps described in connection with FIG. 2-7 may be performed by hardware and/or software (machine readable instructions). If the approach is performed by software, the software may reside in software memory (not shown) in a suitable electronic processing component or system such as one or more of the functional components or modules schematically depicted in the figures.

The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any tangible means that may contain or store the program for use by or in connection with the instruction execution system, apparatus, or device. The tangible computer readable medium may selectively be, for example, but is not limited to, an electronic, magnetic, optical, electromagnetic, infrared, or semiconductor system, apparatus or device. More specific examples, but nonetheless a non-exhaustive list, of tangible computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper (punch cards or punch tape) or another suitable medium upon which the instructions may be electronically captured, then compiled, interpreted or otherwise processed in a suitable manner if necessary, and stored in a computer memory.

The foregoing detailed description of one or more embodiments of the approach for identification of business collaborators has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

1. A method for identification of business collaborators, comprising the steps of:
entering a plurality of key components data associated with a user's project;
searching a data store of project data in response to a controller processing the plurality of key components data;
selecting projects from the project data;
generating a list of potential collaborators who are associated with the projects selected from the project data, where the potential collaborators contained in the collaborators data found in the data store;
ranking the list of potential collaborators to create a list of ranked potential collaborators; and
associating analytics with each of the potential collaborators in the list of ranked potential collaborators.

2. The method for identification of business collaborators of claim 1, where generating a list of potential collaborators, further includes assigning a value to each of the projects selected.

3. The method for identification of business collaborators of claim 2, where assigning the value includes generating a correlation value associated with each of the projects.

4. The method for identification of business collaboration of claim 2, where assigning the value includes weighting the value based upon at least one predetermined parameter.

5. The method for identification of business collaborators of claim 1, where ranking the list of potential collaborators, further includes assigning a value to each of the potential collaborators.

6. The method for identification of business collaborators of claim 5, where assigning the value includes generating a correlation value associated with each of the projects.

7. The method for identification of business collaborators of claim 5, where assigning the value includes weighting the value based upon at least one predetermined parameter.

8. The method for identification of business collaborators of claim 1, where the ranking of potential collaborators further includes accessing an external database to gather additional analytics associated with the potential collaborators.

9. A system that identifies business collaborators, comprising:
a controller;
an input device coupled to the controller the enables entry of a plurality of key components data associated with a user's project;
a data store coupled to the controller, where the data store has project data that is searched in response to entry of the plurality of key components data, and projects identified in response to the search;
a list of potential collaborators who are associated with the projects selected from the project data by the controller, where the potential collaborators contained in the collaborators data in the data store;
a list of ranked potential collaborators created by ranking the list of potential collaborators selected by the controller; and
analytics associated with each of the potential collaborators in the list of ranked potential collaborators.

10. The system that identifies business collaborators of claim 9, where the list of potential collaborators, further includes a value being assigned to each of the projects selected.

11. The system that identifies business collaborators of claim 10, where the value assigned to each project is a correlation value.

12. The system that identifies business collaborators of claim 10, where assignment of the value includes weighting the value based upon at least one predetermined parameter.

13. The system that identifies business collaborators of claim 9, where the list of ranked potential collaborators, further includes a value assigned to each of the potential collaborators.

14. The system that identifies business collaborators of claim 13, where the value includes a correlation value associated with each of the projects.

15. The system that identifies business collaborators of claim 13, where the value includes weighting the value based upon at least one predetermined parameter.

16. The system that identifies business collaborators of claim 9, where the list of ranked potential collaborators further includes an external database accessed to gather additional analytics that are associated with the potential collaborators.

17. A non-transient machine readable media with instructions that when executed implement a method for identification of business collaborators, comprising the steps of:
entering a plurality of key components data associated with a user's project;
searching a data store of project data in response to a controller processing the plurality of key components data;
selecting projects from the project data;
generating a list of potential collaborators who are associated with the projects selected from the project data, where the potential collaborators contained in the collaborators data found in the data store;
ranking the list of potential collaborators to create a list of ranked potential collaborators; and
associating analytics with each of the potential collaborators in the list of ranked potential collaborators.

18. The non-transient machine readable media with instructions that when executed implement a method for identification of business collaborators of claim 17, where generating a list of potential collaborators, further includes assigning a value to each of the projects selected.

19. The non-transient machine readable media with instructions that when executed implement a method for identification of business collaborators of claim 17, where ranking the list of potential collaborators, further includes assigning a value to each of the potential collaborators.

20. The non-transient machine readable media with instructions that when executed implement a method for identification of business collaborators of claim 17, where the ranking of potential collaborators further includes accessing an external database to gather additional analytics associated with the potential collaborators.
